(19) United States
(12) Patent Application Publication
(10) Pub. No.: US 2011/0066897 A1
(43) Pub. Date: Mar. 17, 2011

(54) METHODS AND APPARATUSES FOR DETERMINING PERMANENT MEMORY GROWTH

(76) Inventors: William Bumgarner, San Jose, CA (US); Patrick Beard, Pleasanton, CA (US); Blaine Garst, Los Altos, CA (US); Benjamin Holt, San Jose, CA (US)

(21) Appl. No.: 12/558,445

(22) Filed: Sep. 11, 2009

(51) Int. Cl. G06F 11/07

(52) U.S. Cl. 714/46; 714/E11.029; 714/25

(57) ABSTRACT

Methods and apparatuses that correlate a plurality of snapshots of system resources to identify allocation of permanent resource objects are described. Each snapshot may include an inventory of resource objects already allocated at the time of the snapshot. The plurality of snapshots may be taken at different instants over a period of time. Temporarily allocated resource objects may be filtered from the plurality of snapshots to identify permanent resource objects according to the correlation among the plurality of snapshots.

### FIELD OF INVENTION

The present invention relates generally to run time memory monitoring. More particularly, this invention relates to tracking permanent memory growth for software operating in computer systems.

### BACKGROUND

With the increasing complexity of modern software programs, detecting permanent memory growth has become an integral part of a software life cycle. For example, memory leaks in a program can cause permanent memory growth due to design and/or coding errors, and this memory growth is contrary to the intentions of a design team for managing memory allocation. Often times, poor memory management schemes, such as caching schemes, may also cause undesired permanent memory growth as a result of a long delay in reclaiming allocated memory objects. In particular, caches may be “write only”. More and more data may be put into such caches without ever being retrieved and, as a result, causing significant memory bloat while incurring CPU (Central Processing Unit) overhead. Many software tools have been developed to address the issue of permanent memory growth.

For example, conventional memory leak detection tools are widely used to sample a processor running a program to produce a snapshot that illustrates objects allocated in memory at a given time. A set of inputs is then run through the program and the tools produce a second snapshot which illustrates objects allocated in memory at a second time. A programmer then compares the two snapshots to determine which objects are lingering or leaking using his/her skills and the knowledge of the program logic.

However, a snapshot of allocated objects on a system can include too large a number of objects to be useful for a programmer to analyze. In addition, most of the objects sampled may not be relevant to the program targeted. Alternatively, a special build of the same program injected with memory leak detecting codes can produce a more focused snapshot of objects allocated. Nevertheless, producing such a build can be tedious, time consuming, and error prone in missing critical call paths for identifying memory leaks. Besides, the special build usually costs extra processing cycles during run time and may not be applicable for release as an end product.

Therefore, traditional tools for identifying memory leaks or permanent memory growth do not scale with the increasing complexity of modern software programs.

### SUMMARY OF THE DESCRIPTION

An embodiment of the present invention can include methods and apparatuses that correlate a plurality of snapshots of system resources to identify allocation of permanent resource objects. Each snapshot may include an inventory of resource objects already allocated at the time of the snapshot. The plurality of snapshots may be taken at different instants over a period of time. Temporarily allocated resource objects may be filtered from the plurality of snapshots to identify permanent resource objects according to the correlation among the plurality of snapshots.

In an alternative embodiment, a repeatable action of an application may be performed in between a first sampling (e.g. obtaining a snapshot) and a second sampling of memory nodes allocated for a system running the application. The first and second samplings may include separately first and second collections of memory nodes already allocated for the system at the time of the sampling. The application can maintain the same execution state prior and subsequent to performing the repeatable action. In one embodiment, a repeatable action can be characterized in that the state of an application changes from a first state to a second state by the repeatable action and a de-action returns the application to the first state and this can be repeated. One or more memory nodes representing permanent memory growth of the application related to the repeatable action may be identified from the first and second collections of memory nodes.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating one embodiment of a system to determine permanent memory growth;

FIG. 2 is a block diagram illustrating one embodiment of a system to determine permanent memory growth for an application;

FIG. 3 is a flow diagram illustrating one embodiment of a process to filter temporarily allocated objects from snapshots of resource usage;

FIG. 4 is a block diagram illustrating one embodiment of a process to identify permanently allocated memory nodes via repeatable actions;

FIG. 5 is a sample diagram illustrating a trend of memory growth according to one embodiment of the present invention;

FIG. 6 is a sequence diagram illustrating an example of cross correlation among inventories of memory nodes sampled subsequent to each repeatable action;

FIG. 7 is a sequence diagram illustrating an example of filtering inventories of memory nodes based on cross correlation;

FIGS. 8-9 are sample user interfaces illustrating examples of snapshots identifying permanently allocated memory objects;

FIGS. 10-12 are sample user interfaces illustrating examples of snapshots exploring properties of memory objects;

FIGS. 13-16 are sample user interfaces illustrating sample trends for growth of memory nodes;

FIG. 17 illustrates one example of a data processing system which may be used in one embodiment of the present inventions;

FIG. 18 illustrates one example of another data processing system such as a computer system, which may be used in conjunction with the embodiments described herein.

### DETAILED DESCRIPTION

Methods and apparatuses for determining permanent memory growth are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, memory usage of a target application can be analyzed to identify an accurate record of permanent memory growth. Snapshots for inventories of memory nodes may be taken (or sampled) at well known points of execution of the application. A memory node for the application may represent a memory or resource object allocated within the application. Inventories of memory nodes may be processed such that the moment of creation of each node that remains in existence throughout subsequent snapshots is identified. Analysis of changes among sets of memory nodes from sample to sample may provide an accurate record on when (e.g. on which sampling instant) and how (e.g. based on which part of the source codes) a particular memory node comes into existence.

In one embodiment, an action from an application can be repeated in between samples. Inventories of memory nodes per sample can be compared to determine an average and a peak rate of memory growth caused by the action. In some embodiments, automatic scripts can measure accurately a lag in memory reclamation caused by a caching mechanism or other infrastructure that causes delayed reclamation based on a sequence of repeated actions and samples for the application. As a result, repeated memory growth and/or bad caching behavior can be quickly identified.

In one embodiment, cross correlation among inventories of memory nodes can be used to filter memory nodes to provide a graphical presentation of permanent memory growth which is much less noisy and much more informative than presentations using unfiltered memory nodes. For example, an inventory including about 16K-20K chaotic and random memory nodes sampled for an application can be filtered down to 4 easily manageable memory nodes which persist across repeatable actions.

In some embodiments, cross correlation among memory nodes can be used to identify the presence of memory leaks from a small number of samples of memory nodes. For example, three samples (e.g. taken in a sequence) may be sufficient for detection memory leaks: a first sample of memory nodes can include a baseline of memory nodes (e.g. due to memory allocation when a system or application warms up, such as filling up caches); a second sample of memory nodes may allow filtering of memory nodes representing temporarily allocated objects; and a third sample of memory nodes may serve as a current instant for cross correlation.

A low level run time environment, e.g. based on the C or Objective-C programming languages, may accurately reveal permanent memory growth via cross correlation. In some embodiments, when coupled with a mechanism to record the stack at the moment of allocating a memory object, a subsystem of an application can be measured in terms of permanent memory usage cost via cross correlation.

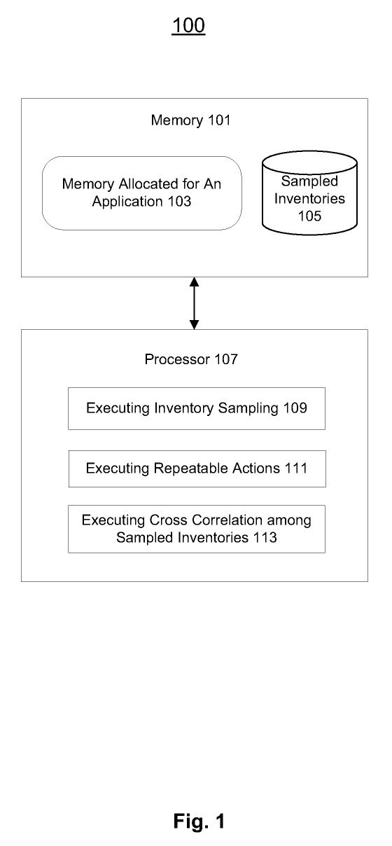

FIG. 1 is a block diagram illustrating one embodiment of a system to determine permanent memory growth. System 100, such as in a data processing system or a computer, can include processor 107 coupled with memory 101 to execute instructions retrieved from memory 101 for an application. System resources required for running the application may include allocated memory for the application 103. During run time, the amount of system resources allocated for the application may vary at different instants of time due to, for example, changes of states in the application, workings of resource management schemes supporting the application, and/or other unknown allocations (or memory leaks). A state of an application may include a collection of total memory objects allocated for the application. A resource management scheme may determine allocation and de-allocation of memory resources for the application. Usually, unknown allocations (or memory leaks) in the application may not be reclaimed (or de-allocated) via memory management even when these unknown allocations are not needed in the application.

In one embodiment, processor 107 may perform operations for extracting information regarding run time memory usage for an application to detect possible memory leaks. For example, processor 107 can execute inventory sampling 111 to access statuses or inventories of resource usage at different points in time (or instants). Resource usage may include memory objects or other resources allocated in system 101. An inventory may include a list of memory nodes representing memory objects allocated in memory 101 at the instant when sampled. In one embodiment, sampled inventories 105 may store a history of inventories sampled from memory 101 for later references. Sampled inventories 105 may be located in memory 101 or other storage devices locally or remotely coupled with processor 107.

Process 107 may execute repeatable actions 109 to move an application to and from a particular state for determining if the application causes memory leaks. The application may maintain the same state prior and subsequent to performing a repeatable action. Usually, a repeatable action may be followed by an inventory sampling to detect existence of memory leaks. In some embodiment, processor 107 may perform cross correlation among multiple sampled inventories, such as stored in sampled inventories 105, to identify potential memory leaks from among sampled memory nodes across different inventories. The cross correlation can reveal certain memory nodes as potential memory leaks from among a large number of memory nodes represented by the sampled inventories.

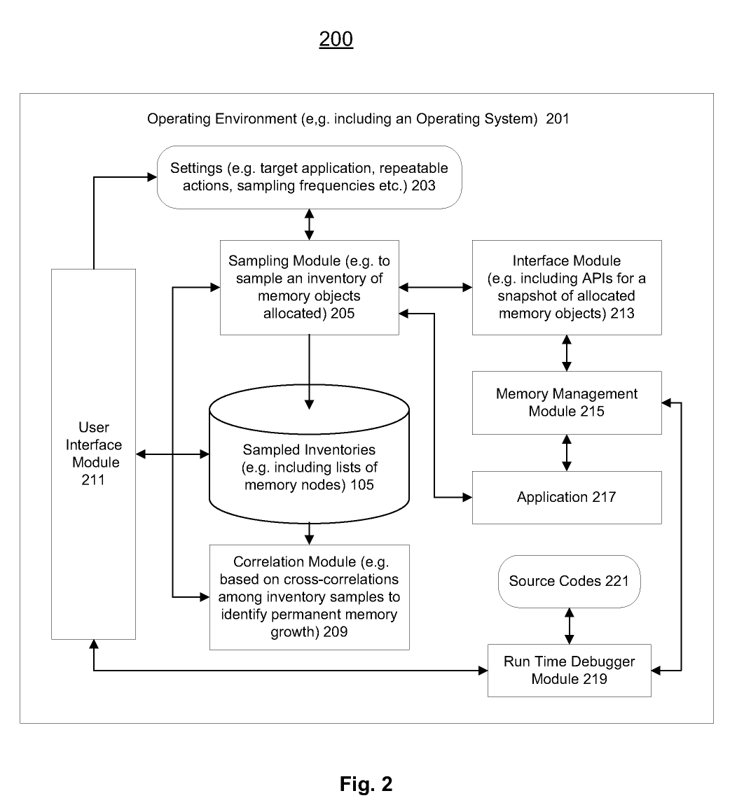

FIG. 2 is a block diagram illustrating one embodiment of a system to determine permanent memory growth for an application. System 200 may include an operating environment 201 for a data processing system, such as an operating system. In one embodiment, operating environment 201 may reside in a memory such as memory 101 including sampled inventories 105 of FIG. 1. A sampling module 205 can take a snapshot of current resource objects (or memory objects) allocated in system 200 for an application 217. A snapshot may include a list of memory nodes, each node representing an object allocated in memory at the time of the snapshot. For example, an object may correspond to system or application object such as a window, a menu bar, a file handler, a network port, a button, an icon, a drawing context, a thread, a process, or simply a memory space allocated in a heap, . . . etc. Each memory node may include properties or attributes characterizing an object allocated in memory, such as a size (e.g. in K Bytes), an address (or location) in memory, a type, a memory zone, and/or other attributes, etc. A type of an object may indicate a category of system or application objects associated with the object, such as a window, a menu bar, an event, an array, a network port, or other objects in an operating system, etc. An inventory may correspond to a full list of memory nodes allocated for the whole system or an application at an instant.

In one embodiment, sampling module 205 may send a sampling request, e.g. via APIs (Application Programming Interfaces), to an interface module 213 for an inventory of memory objects currently allocated (e.g. for application 217 or system 200). In turn, interface module 213 may retrieve a list of memory nodes currently allocated via a memory management module 215 which maintains allocation/de-allocation of objects for system 201. Sampling module 205 can store the retrieved inventory in sampled inventories 105 according to a sampling time sequence. The sampling request may indicate a target application, such as application 217, for taking a snapshot of inventory. In some embodiment, an inventory can include memory nodes for objects previously allocated for a target application but have already been reclaimed and cached in a memory cache.

Sampling module 205 can request application 217 to perform a repeatable action to take snapshots of inventories for comparison. An application can maintain the same application state after performing a repeatable action. For example, a document processing application typically does not change states by a repeatable action such as opening then closing a document. In some embodiments, sampling module 205 includes scripts configured by settings 203 to automatically iterate, for a period of time, taking snapshots and instructing application 217 to perform repeatable actions. Settings 203 may include a schedule for iterations of snapshots (e.g. sampling frequencies), identifiers for repeatable actions, identifiers of target applications, and/or other parameters.

In one embodiment, correlation module 209 can compare a sequence or a history of inventories to cross correlate memory nodes sampled at different instants to identify which memory objects may be permanently allocated (e.g. causing memory leaks). Correlation module 209 can filter out memory nodes which represent memory objects allocated temporarily in an inventory. A temporally allocated memory object can be present in one earlier inventory (e.g. based on the sampling instant) but absent in a later inventory after being reclaimed. Correlation module 209 can determine if two memory nodes from separate inventories represent the same memory object according to properties/attributes associated with each memory node.

In one embodiment, user interface module 211 can allow a user to control sampling module 205 for taking snapshots of inventories and/or performing repeatable actions for application 217. User interface module 211 can generate a diagram depicting a trend of memory growth based on sampled inventories 105. When inventories are filtered by correlation module 209, the diagram can reveal memory growth due to permanently allocated memory objects. User interface module 211 can also update settings 203 for configuring a script to drive sampling module 205 and/or application 217 automatically to generate snapshots of inventories. When coupled with run time debugger module 219, user interface module 211 may allow a user to map a permanently allocated memory object (or memory leak) to a corresponding location in source codes 221 for application 217.

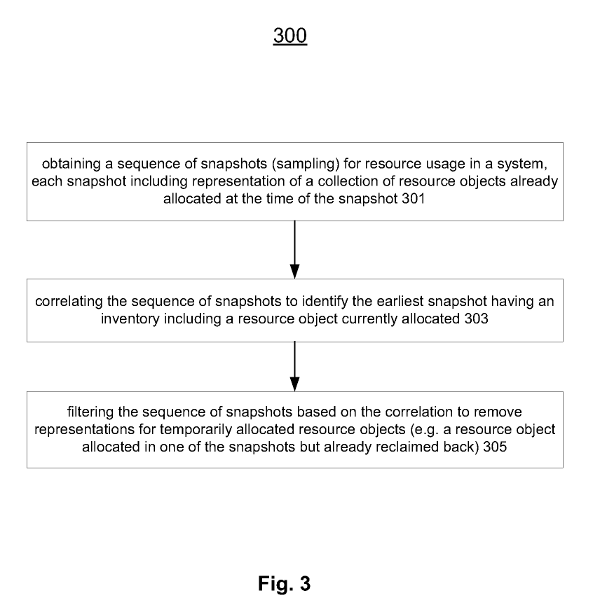

FIG. 3 is a flow diagram illustrating one embodiment of a process to filter temporarily allocated objects from snapshots of resource usage. Exemplary process 300 may be performed by a processing logic that may comprise hardware (circuitry, dedicated logic, etc.), software (such as is run on a dedicated machine), or a combination of both. For example, process 300 may be performed by some components of system 200 of FIG. 2. In one embodiment, at block 301, the processing logic of process 300 can sample a sequence of snapshots for resource usage at different points in time. Each snapshot can include representation of a collection of resource objects already allocated at the time of the snapshot. For example, a snapshot can sample an inventory of memory nodes each representing a memory object already allocated at the time (or instant) of the sampling.

At block 303, in one embodiment, the processing logic of process 300 can correlate a sequence of snapshots to identify the earliest snapshot having an inventory including a particular resource object currently allocated. An inventory for a snapshot may include a collection of separate memory nodes, each representing a resource object (e.g. memory object) currently allocated. The processing logic of process 300 can determine which memory nodes among inventories of the sequence of snapshots node representing the same memory object currently allocated, e.g. based on an inventory for the latest snapshot. For example, two memory nodes may represent the same memory object if both memory nodes are associated with a common memory location and having a common type. In one embodiment, separate memory nodes sharing one or more common attributes (e.g. same location) may represent separate memory objects allocated if the memory nodes are associated with different types. The processing logic of process 300 may identify groups of memory nodes from the sequence of snapshots, each group of memory nodes representing one single memory object (e.g. currently allocated) across different snapshots.

According to one embodiment, at block 305, the processing logic of process 300 can filter a sequence of snapshots to remove representations of temporarily allocated resource objects based on correlation among the sequence of snapshots. For example, the processing logic of process can filter memory nodes which do not represent any currently allocated memory objects from inventories of a sequence of snapshots. Additionally, the processing logic of process 300 can filter memory nodes such that at most one memory node may represent a currently allocated memory object among the sequence of snapshots. In one embodiment, memory nodes representing the same memory object currently allocated among the sequence of snapshots are filtered except for the earliest memory node (e.g. based on sampling instants of the snapshots). Consequently, the sequence of filtered snapshots can reveal currently allocated memory objects which are permanent (e.g. related to memory leaks). In some embodiments, the processing logic of process 300 may take a baseline inventory for resource objects which can be excluded from consideration as being memory leaks. The processing logic of process 300 may filter each inventory of a snapshot according to the baseline taken earlier.

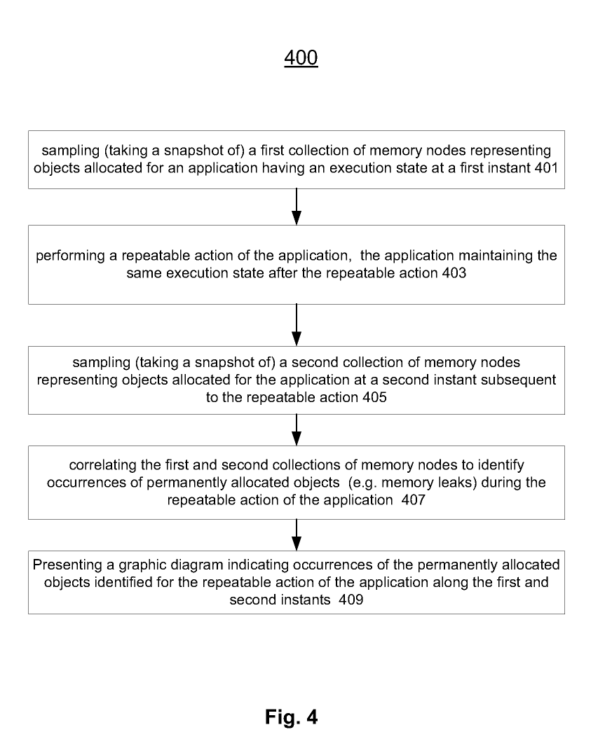

FIG. 4 is a block diagram illustrating one embodiment of a process to identify permanently allocated memory nodes via repeatable actions. Exemplary process 400 may be performed by a processing logic that may comprise hardware, software, or a combination of both. For example, process 400 may be performed by some components of system 200 of FIG. 2. In one embodiment, at block 401, the processing logic of process 400 can sample (or taking a snapshot) a first collection of memory nodes representing objects allocated for an application at a first instant. The application may have a state (or an execution state) at the first instant when the first collection of memory nodes is sampled. Usually, during run time, an application maintains the same execution state if no actions are performed.

Subsequently, at block 403, in one embodiment, the processing logic of process 400 can perform a repeatable action of the application. An application may maintain the same state when performing a repeatable action, such as open/close a document for a document processing application. For example, opening a document in an application and then closing the document in the application can be an example of a repeatable action in which the state of the application before the opening and after the closing can be the same or substantially the same with minimal changes. A minimal change in the state of the application may include, for example, an update on a record in the application to record most recently opened documents. After a sufficient number of opening and closing a document as repeatable actions in the application, such a record may remain unchanged with additional repeatable action to open and close the same document. In one embodiment, to maintain a state when performing an action in an application, each resource object allocated for the application during the action may be reclaimed from the application when the action is completed. A resource object reclaimed from the application may be stored in a cache for performance consideration without changing the state of the application.

After performing a repeatable action at block 405, according to one embodiment, the processing logic of process 400 can sample a second collection of memory nodes representing objects allocated for the application after the repeatable action is completed. Normally, a repeatable action does not cause growth in permanently allocated memory. Thus, an object permanently allocated during a repeatable action can be a candidate for memory leaks. In one embodiment, at block 407, the processing logic of process 400 can correlate the first and second collections of memory nodes to identify occurrences of permanently allocated resource objects during the repeatable action of the application. The processing logic of process 400 can identify newly allocated resource objects represented in the second collection of memory nodes (with respect the first collection), e.g. based on determining if two memory nodes separately from the first and the second collection represent a same resource object.

In some embodiments, the processing logic of process 400 can identify permanently allocated resource objects from iterations of sampling and performing the repeatable action. It is appreciated that as the number of iterations increases, the processing logic of process 400 can filter out more resource objects as permanently allocated. In one embodiment, a snapshot can include an inventory for allocated memory objects currently exist in a system. Thus an inventory can include representation for each temporarily allocated memory object from different operations of the system, such as mounting a file system, opening/closing network connections, or responding to changes in wireless signals, etc. A temporarily allocated memory object may be subjected to different caching schemes imposed by the system. Consequently, the number of iterations (or time span) required for a temporarily allocated object to be reclaimed may vary widely. Similarly, certain resource objects may be allocated for the repeatable action without being reclaimed right after the repeatable action. A caching scheme may cache a resource object allocated for an application until when the cache is cleaned up or updated.

In one embodiment, at block 409, the processing logic of process 400 can present a diagram indicating occurrences of permanently allocated resource objects identified for the repeatable action of the application along sampling instants. The diagram may exclude resource objects temporarily allocated to show a growth trend of permanently allocated resource objects (e.g. memory leaks) for the application. In some embodiments, the processing logic of process 400 may present a diagram indicating memory growth including both permanent and temporarily allocated resource objects.

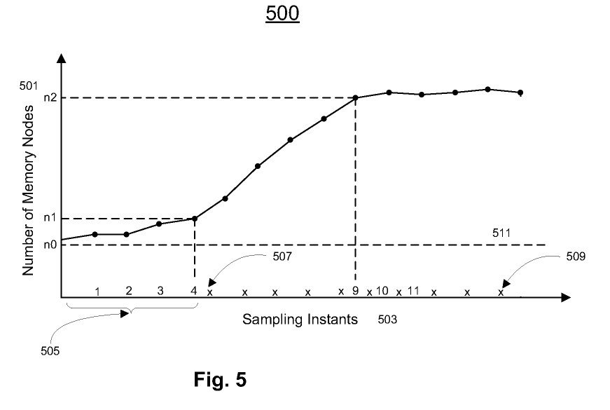

FIG. 5 is a sample diagram illustrating a trend of memory growth according to one embodiment of the present invention. For example, diagram 500 may be presented according the processing logic of process 400 of FIG. 4. In one embodiment, diagram 500 may present growth in number of memory nodes 501 for a system over a series of sampling (or snapshot) instants 503. The number of memory nodes 501 may represent the number of memory objects allocated at the corresponding system. In some embodiment, the number of memory nodes n0 for the first sampling may be used as a baseline 511 for presenting growth of memory nodes.

Preceding a sampling instant, an application may perform the same repeatable action 507 . . . 509 to exercise a portion of codes for the application. As indicated, the system and/or the application may be warming up during the initial period 505 for the first five sampling instants (0-4). Memory objects such as buffers or initial caches may be allocated by the system and/or application during a warming up period. The number of memory nodes sampled may grow from n0 to n1 during period 505. Subsequently, the application may perform the repeatable action 507 . . . 509 preceding each sampling instant. For the first five repeatable actions, the number of memory objects allocated may grow from n1 to n2, signifying, for example, the system caching allocated memory objects for the repeatable actions. However, the number of memory nodes sampled may stabilize after sampling instant 9, which may indicate the system and/or the application replaces cached memory objects.

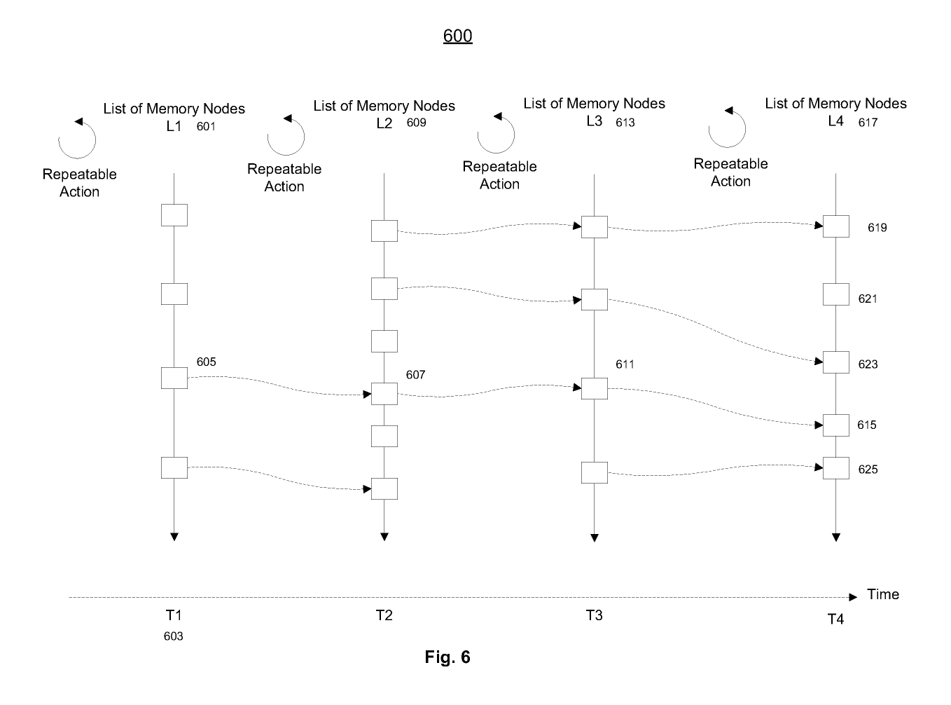

FIG. 6 is a sequence diagram illustrating an example of cross correlation among inventories of memory nodes sampled subsequent to each repeatable action. For example, diagram 600 may be based on snapshots of resource objects allocated for a system, such as system 200 of FIG. 2. Diagram 600 may include, as an example, list L1 601 for an inventory of at least 4 memory nodes sampled at instant T1 603. List L1 601 may represent the whole set of memory objects allocated for a system and/or application. In one embodiment, List L1 601 may exclude memory nodes which are also present in a baseline list, which may represent memory objects initially allocated not to be considered as potential memory leaks.

In one embodiment, cross correlation may be based on comparison between memory nodes from inventories adjacent in associated sampling instants. For example, node 605 from L1 601 may be correlated with node 607 of L2 609. Nodes 605, 607 may be correlated if one or more properties/attributes (e.g. address, type, . . . ) associated with the nodes share common values. Nodes 607, 611 and nodes 611, 615 may be similarly correlated. In some embodiments, correlations may be established across more than two inventories, such as nodes 605, 607, 611 and 615 across inventories L1 601, L2 609, L3 613 and L4 617. According to cross correlation in diagram 600, node 621 of L4 617 may represent a memory object allocated after time T3. Memory nodes from inventories L1 601, L2 609 and L3 613 may not be correlated with node 621.

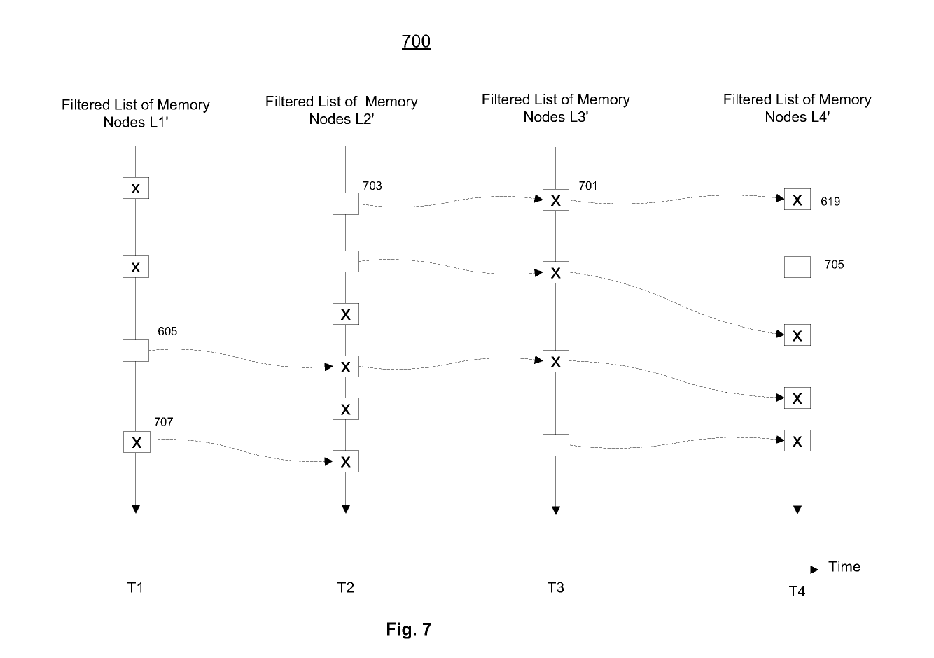

FIG. 7 is a sequence diagram illustrating an example of filtering inventories of memory nodes based on cross correlation. For example, diagram 700 may indicate filtered memory nodes included in diagram 600 of FIG. 6. In one embodiment, memory nodes may be filtered based on a current inventory of the latest sampling instant, such as L4 of instant T4 in FIG. 6. Memory nodes may be marked based on cross correlation among a history of inventories, e.g. L1, L2, L3 and L4 of FIG. 6. In one embodiment, a memory node may be marked if it is correlated with at least one of memory nodes in the currently inventory, e.g. node 627. A memory node, e.g. node 703, may not be marked if it is of the earliest inventory among a group of correlated nodes including one in the current inventory. A memory node, e.g. node 705, in the current inventory may not be marked if it is not correlated with other memory nodes in the history of inventories. A memory node, e.g. node 707, may be market if it is not correlated with any node in the current inventory.

In one embodiment, memory nodes which are marked may be filtered. For example, filtered list L1′ may include a memory node 605 which is not marked. A filtered list of memory nodes for an inventory may include memory nodes representing memory objects which have been newly allocated at the sampling instant corresponding to the inventory while still persist at the current instant. Thus, memory nodes representing temporarily allocated memory objects may be filtered according to cross correlation. A filtered list of memory nodes in an inventory sampled may indicate potential persistent memory objects allocated (e.g. memory leaks). As indicated in diagram 700, filtered lists L1′, L2′, L3′ may include smaller number of memory nodes to provide a more focused scope in identifying memory leaks, when compared with original lists L1, L2, and L3 of FIG. 6.

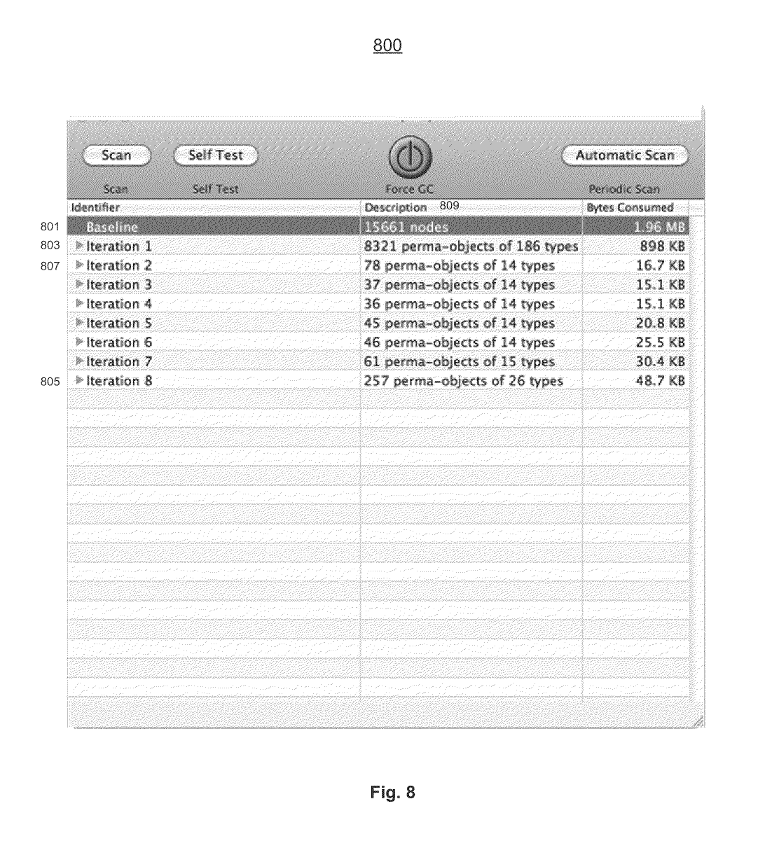

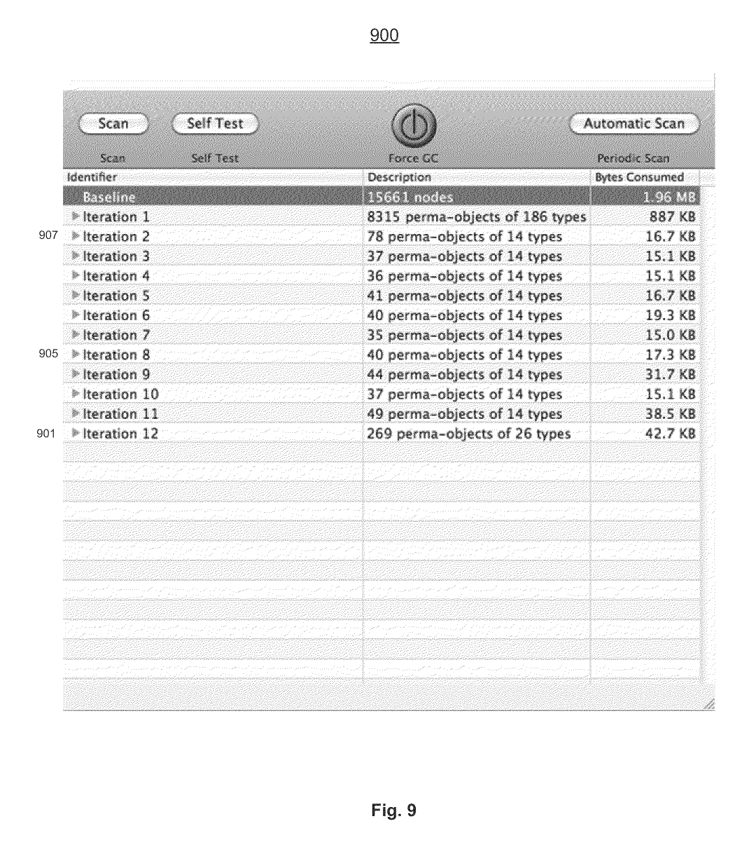

FIGS. 8-9 are sample user interfaces illustrating examples of snapshots identifying permanently allocated memory objects. For example, interfaces 800 and 900 may be presented based on user interface module 211 of FIG. 2. In one embodiment, interface 800 can include summaries of filtered inventories of memory nodes based on a history of 8 iterations of inventory sampling or snapshots against a system running an application, such as system 100 of FIG. 1. For example, interface 800 may include a baseline snapshot 801 representing 15661 memory nodes occupying 1.96 Kbytes of memory space. Each iteration may indicate a number of filtered memory nodes according to cross correlation at iteration 8 805 as the current inventory. For example, 8321 memory nodes allocated at iteration 1 803 may persist at iteration 8 805. However, a far smaller number of 78 memory nodes persist from iteration 2 807 to iteration 8 805. Note that each of memory nodes indicated in the description 809 may represent a unique memory object allocated among the history of iterations 1-8. In one embodiment, the application may perform a repeatable action preceding each iteration of inventory sampling.

Turning now to FIG. 9, interface 900 may include summaries of filtered inventories of memory nodes based on a history of 12 iterations of inventory sampling including the first 8 iterations as in FIG. 8. Each iteration may indicate a number of filtered memory nodes according to cross correlation at iteration 12 901 as the current inventory. For example, iteration 8 905 may include 40 filtered memory nodes persist through iteration 12 901. As indicated, of the 257 filtered memory nodes identified at iteration 8 805 of FIG. 8, 217 memory nodes represent temporarily allocation memory objects.

Permanently allocated memory objects (e.g. memory leaks) represented by filter memory nodes may be consistently identified from iteration to iteration. For example, 78 filtered memory nodes may be identified for iteration 2 907 and iteration 2 807 of FIG. 8 separately based on iteration 8 905 iteration 12 901 as current iteration. Filtered memory nodes which are substantially consistent (e.g. consistent over a specified number of iterations or period of time) may signify occurrences of reproducible memory leaks.

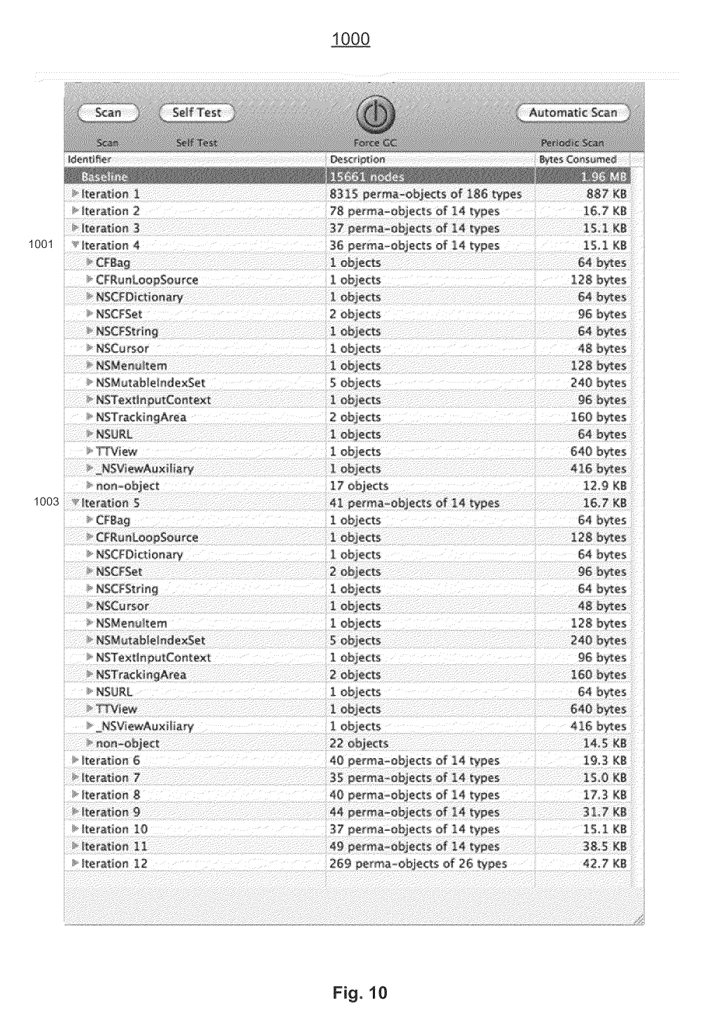

FIGS. 10-12 are sample user interfaces illustrating examples of snapshots exploring properties of memory objects. For example, interfaces 1000 and 1100 may include summaries of filtered inventories of memory nodes according to cross correlation at iteration 12 as similarly presented via interface 900 of FIG. 9. In one embodiment, interfaces 1000, 1100 and 1200 may be generated via user interface module 211 integrated with run time debugger module 219 of FIG. 2. Expanded lists for iteration 4 1001 and iteration 5 1003 may include type identifiers for filtered memory nodes representing permanently allocated memory objects.

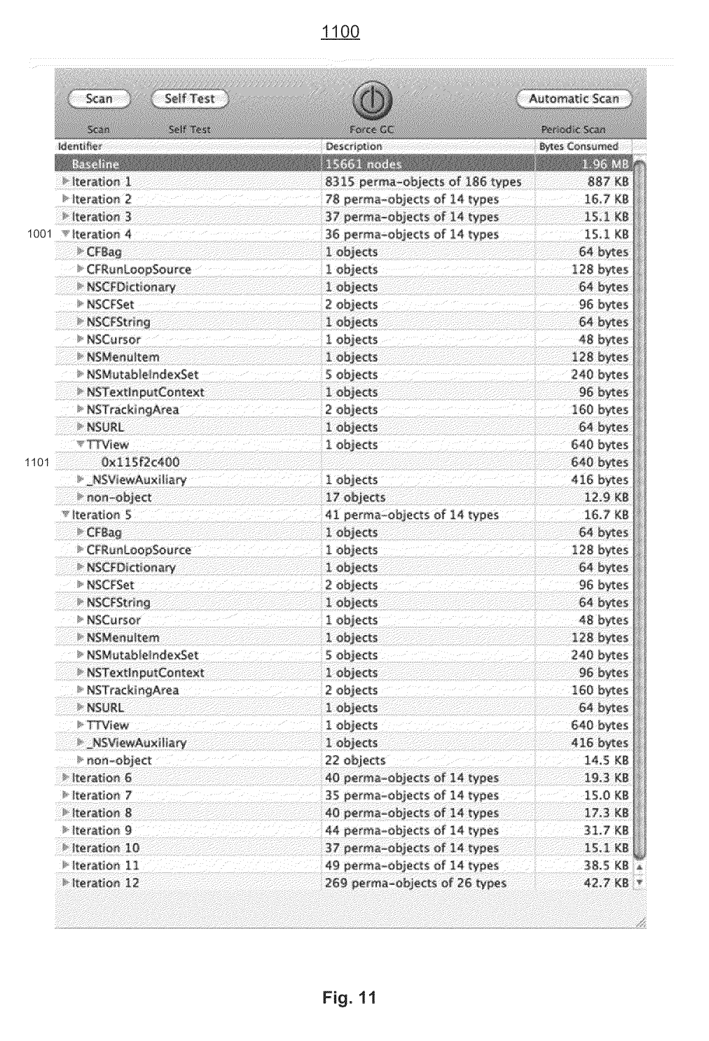

Turning now to FIG. 11, interface 1100 may include further expanded iteration fields to display properties of a memory node, such as the address of the corresponding memory object. For example, field 1101 may indicate an address of a permanently allocated memory object identified by type “TTView” for iteration 4 1001. It is appreciated that exact locations in a source code which allocates a memory object may be determined via run time debugging tool, such as run time debugger module 219 using source codes 221 in FIG. 2.

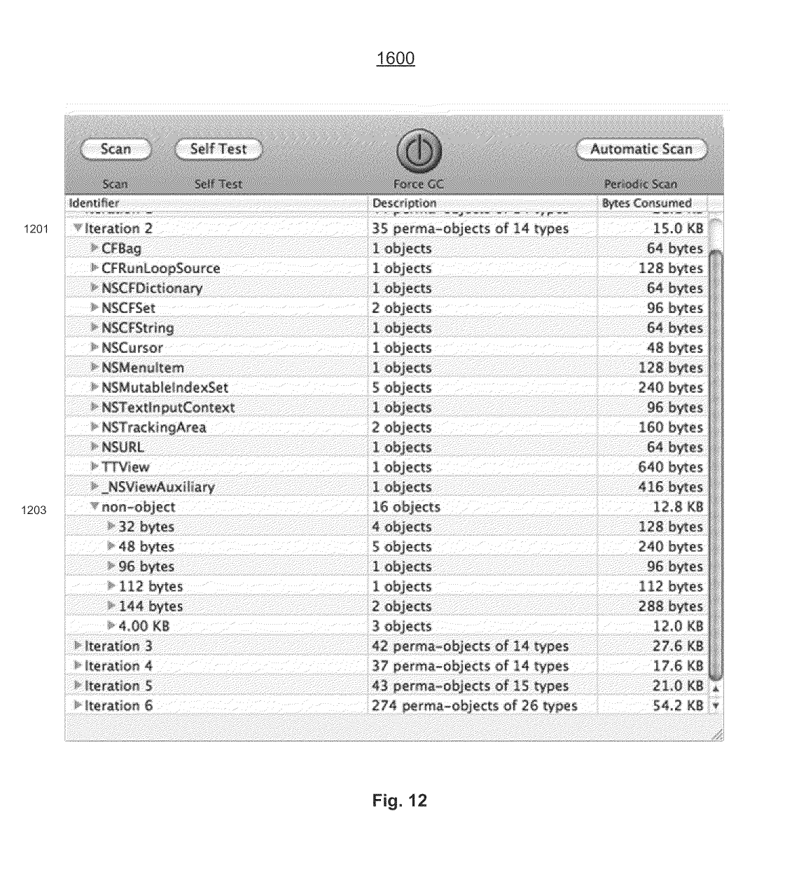

Turning now to FIG. 12, interface 1200 may include further expanded iteration fields to display properties of a memory node, such different sizes for the corresponding memory objects having a same type. For example, field 1203 may indicate a break down of 16 permanently allocated memory objects of type “non-type” according to allocation sizes within iteration 2 1201. Usually, memory leaks from memory objects of type “non-type” can be problematic. Such break down may provide assistance to correlate trends across different iterations for different types of memory objects.

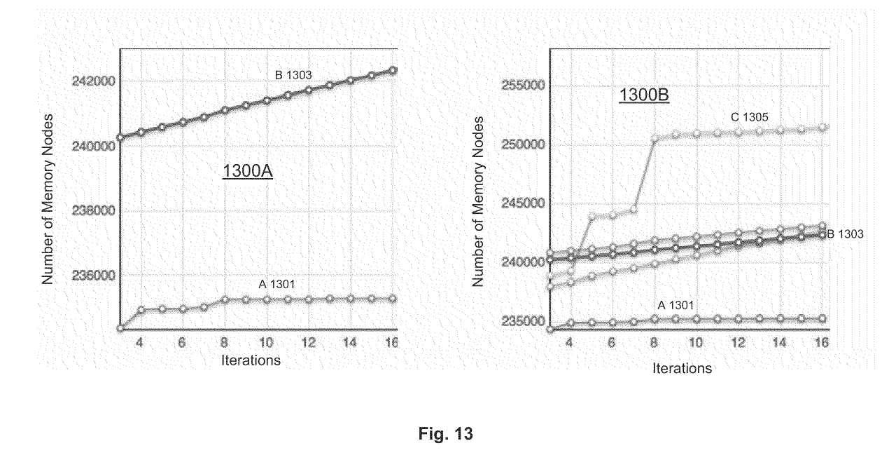

FIGS. 13-16 are sample user interfaces illustrating sample trends for growth of memory nodes. For example, interfaces 1300A, 1300B, 1400, 1500 and 1600 may be generated via user interface module 211 of FIG. 2. In one embodiment, interfaces 1300A and 1300B may include comparison of growth trends of permanently allocated memory objects for different builds of software code (e.g. for an application) over time. Interface 1300A may include growth trend B 1303 and growth trend A 1301 from two separate builds of the same software. Interface 1300B may include an additional trend C 1305 from another build of the same software in comparison with both trends A 1301 and B 1303. Regression from trend A 1301 to trend B 1303 may be discernible in both interfaces 1300A and 1300B. Trend C 1305 may indicate presence of serious memory leaks.

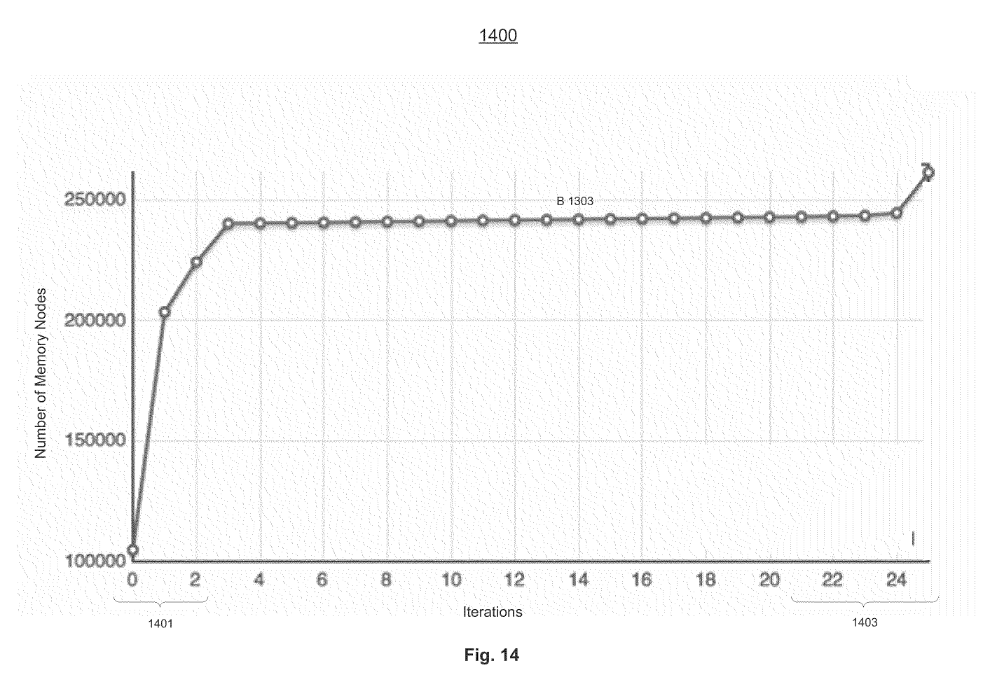

Turning now to FIG. 14, interface 1400 may demonstrate effects on a growth trend of permanently allocated memory objects for the first several iterations and the last (or current) iteration. Interface 1400 may include trend B 1301 as in FIG. 13. During the first three iterations 1401, memory objects may be allocated permanently to warm up a system or application instead of leaking memory. Similarly, during the last five or so iterations 1403, temporary memory objects may be allocated to be reclaimed later, and filtered out via cross correlation at a later iteration. An interface for a memory growth trend omitting the first couple of iterations may better indicate presence of potential memory leaks as the scale range is reduced for the number of memory nodes (e.g. along y axis).

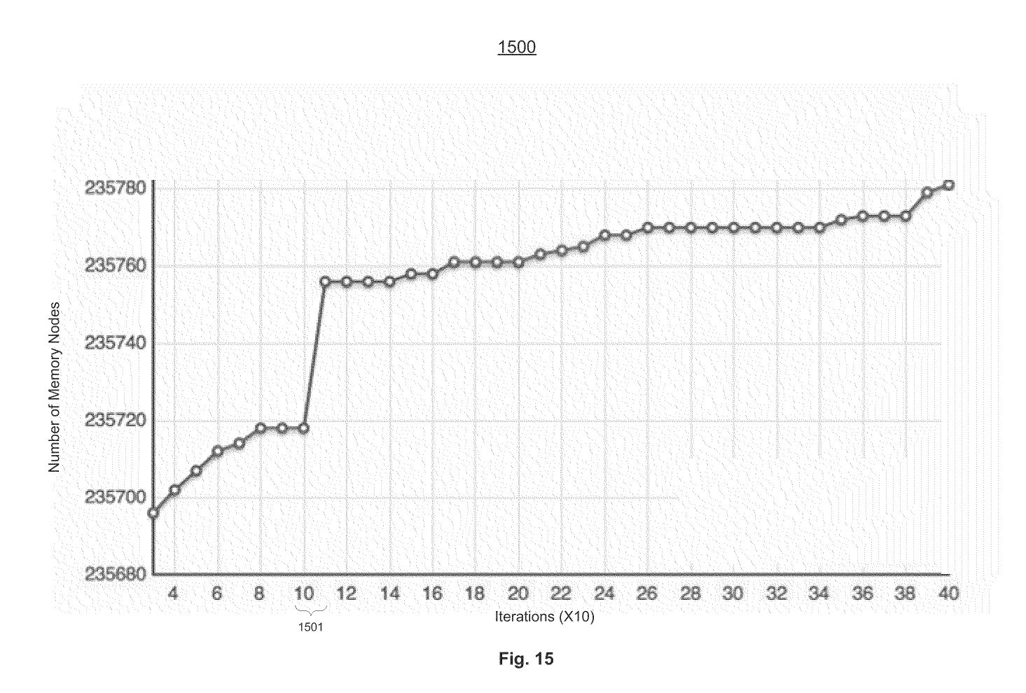

Turning now to FIG. 15, interface 1500 may demonstrate an example of normal growth trend of permanently allocated memory objects generated at iteration 500. A spike around iteration 100 1501 can be expected as the corresponding application initiates a check right before iteration 100 for new documentation and causes allocation of several memory objects in the heap. As the check occurs only once, the corresponding spike in memory growth may not be counted against overall memory performance for the application. In one embodiment, interface 1500 may indicate whether a growth trend of permanent memory objects is acceptable for the corresponding software. For example, if a growth rate is less than a certain percentage (e.g. 4% in at least 50% of samples), a corresponding growth trend may be presented in color green to indicate passing of memory leak test. If a growth rate is more than a certain percentage (e.g. 4% in at least 75% of samples), in one embodiment, a corresponding growth trend may be presented in color red to indicate potential memory leaks. Other colors may be used for different results.

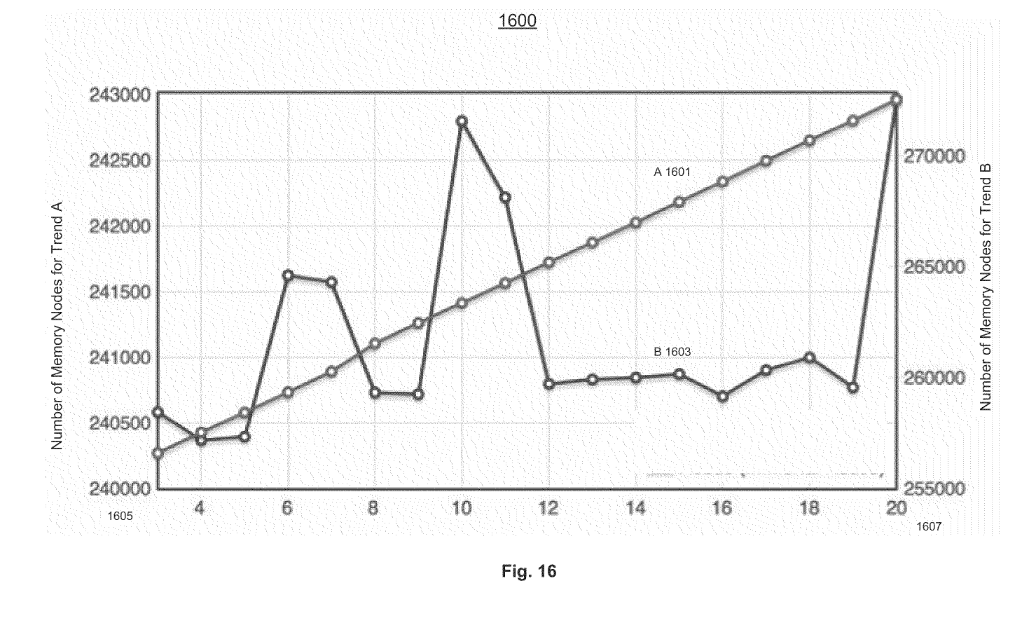

Turning now to FIG. 16, interface 1600 may demonstrate filtering effect of cross correlation comparing filtered trend A 1601 and unfiltered trend B 1603. Unfiltered trend B 1603 may be plotted according to Y axis 1607 for the number of memory nodes. Unfiltered trend B 1603 may be based on the total memory objects including both permanently allocated and relatively short lived (temporarily) ones at each iteration (or snapshot). Filtered trend A 601 may be plotted according to Y axis 1605 for the number of memory nodes. Filtered trend A 601 may be based on memory objects which are permanently allocated at each iteration. In some embodiments, trend A 1601 may represent permanent heap growth produced from trend B 1603 which includes raw data for memory objects allocated.

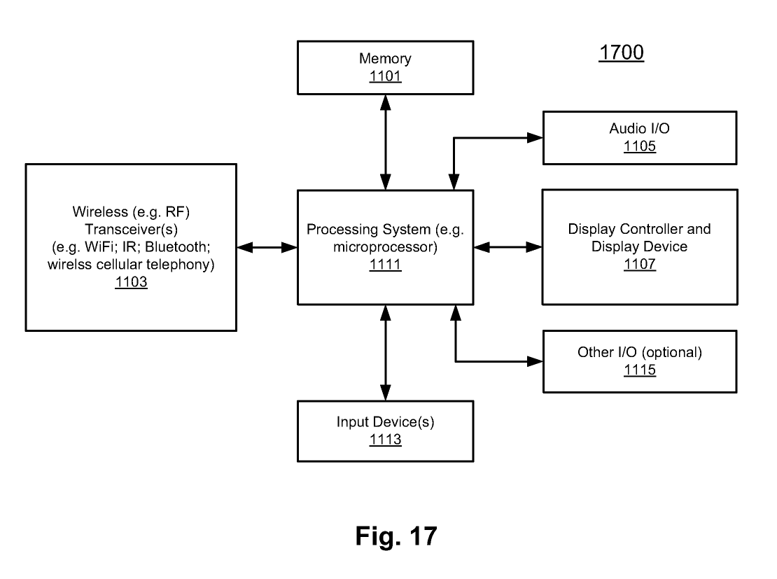

FIG. 17 shows an example of a data processing system 1700 which may be used with one embodiment of the present invention. For example, system 1700 may be implemented as part of system as shown in FIG. 1. The data processing system 1700 shown in FIG. 17 includes a processing system 1711, which may be one or more microprocessors, or which may be a system on a chip integrated circuit and the system also includes memory 1701 for storing data and programs for execution by the processing system. The system 1700 also includes an audio input/output subsystem 1705 which may include a microphone and a speaker for, for example, playing back music or providing telephone functionality through the speaker and microphone.

A display controller and display device 1707 provide a visual user interface for the user; this digital interface may include a graphical user interface which is similar to that shown on an iPhone® device when running iPhone® operating system software. The system 1700 also includes one or more wireless transceivers 1703 to communicate with another data processing system, such as the system 1700 of FIG. 17. A wireless transceiver may be a WiFi transceiver, an infrared transceiver, a Bluetooth transceiver, and/or a wireless cellular telephony transceiver. It will be appreciated that additional components, not shown, may also be part of the system 1700 in certain embodiments, and in certain embodiments fewer components than shown in FIG. 17 may also be used in a data processing system.

The data processing system 1700 also includes one or more input devices 1713 which are provided to allow a user to provide input to the system. These input devices may be a keypad or a keyboard or a touch panel or a multi touch panel. The data processing system 1700 also includes an optional input/output device 1715 which may be a connector for a dock. It will be appreciated that one or more buses, not shown, may be used to interconnect the various components as is well known in the art. The data processing system shown in FIG. 17 may be a handheld computer or a personal digital assistant (PDA), or a cellular telephone with PDA like functionality, or a handheld computer which includes a portable gaming device, or a cellular telephone, or a media player, such as an iPod, or devices which combine aspects or functions of these devices, such as a media player combined with a PDA and a cellular telephone in one device. In other embodiments, the data processing system 1700 may be a network computer or an embedded processing device within another device, or other types of data processing systems which have fewer components or perhaps more components than that shown in FIG. 17.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s).

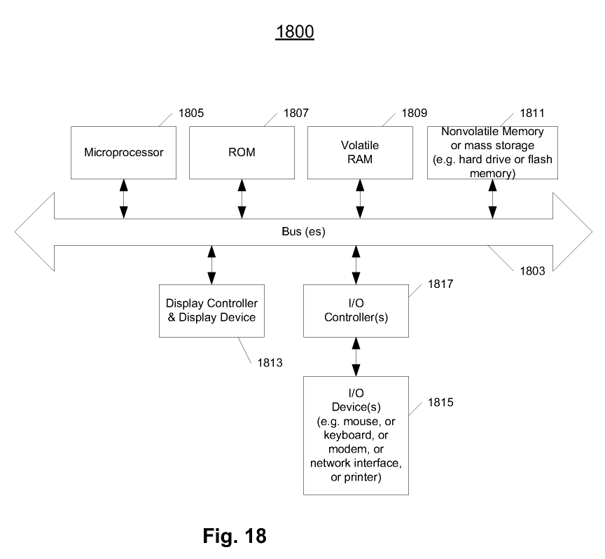

FIG. 18 shows one example of another data processing system such as a computer system, which may be used with one embodiment the present invention. For example, the system 1800 may be implemented as a part of the system shown in FIG. 1. Note that while FIG. 18 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 18, the computer system 1800, which is a form of a data processing system, includes a bus 1803 which is coupled to a microprocessor(s) 1805 and a ROM (Read Only Memory) 1807 and volatile RAM 1809 and a non-volatile memory 1811. The microprocessor 1805 may retrieve the instructions from the memories 1807, 1809, 1811 and execute the instructions to perform operations described above. The bus 1803 interconnects these various components together and also interconnects these components 1805, 1807, 1809, and 1811 to a display controller and display device 1813 and to peripheral devices such as input/output (I/O) devices which may be mice, keyboards, modems, network interfaces, printers and other devices which are well known in the art. Typically, the input/output devices 1815 are coupled to the system through input/output controllers 1817. The volatile RAM (Random Access Memory) 1809 is typically implemented as dynamic RAM (DRAM) which requires power continually in order to refresh or maintain the data in the memory.

The mass storage 1811 is typically a magnetic hard drive or a magnetic optical drive or an optical drive or a DVD RAM or a flash memory or other types of memory systems which maintain data (e.g. large amounts of data) even after power is removed from the system. Typically, the mass storage 1811 will also be a random access memory although this is not required. While FIG. 18 shows that the mass storage 1811 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 1803 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer implemented method, comprising:
obtaining a plurality of snapshots for resource usage at different times, each snapshot indicating a collection of resource objects already allocated at a time of the snapshot;
correlating the plurality of snapshots, the correlation identifying permanent resource objects from the collection of resource objects; and
filtering the plurality of snapshots based on the correlation, wherein the filtered snapshots indicating the permanent resource objects identified.

2. The method of claim 1, wherein the plurality of snapshots include a last snapshot and wherein the correlation comprises:
determining two or more snapshots indicating a common resource object, the two or more snapshots including an earliest snapshot and a latest snapshot for the common resource object among the plurality of snapshots, wherein the common resource object is a permanent resource object if the latest snapshot is the last snapshot.

3. The method of claim 2, wherein each of the two or more snapshots includes a representation representing the common resource object and wherein the representation includes one or more attributes.

4. The method of claim 3, further comprising:
comparing representations of the common resource object among the one or more snapshots, wherein the representations of the common resource object share at least one of the attributes.

5. The method of claim 4, wherein the shared attributes include a type of the common resource object.

6. The method of claim 2, wherein the last usage snapshot indicates a last collection of resource objects and wherein the last collection of resource objects includes the permanent resource objects.

7. The method of claim 1, wherein the filtered snapshot indicates an earliest time for allocating the permanent resource objects identified and wherein each of the permanent resource objects is uniquely indicated in the filtered snapshot among the plurality of filtered snapshots.

8. The method of claim 1, further comprising:
presenting a graphical user interface indicating growth of permanent resource objects for a period of time corresponding to the plurality of snapshots.

9. A computer implemented method, comprising:
obtaining a snapshot of a first collection of memory nodes allocated for a system running an application having an execution state at a first instant;
performing a repeatable action of the application subsequent to the first instant, wherein the application maintains the execution state after the repeatable action;
obtaining a snapshot of a second collection of memory nodes allocated for the system running the application at a second time instance subsequent to the repeatable action; and
identifying one or more memory nodes from the first and second collections of memory nodes, the identified memory nodes representing permanent memory growth of the application along the first and second instants.

10. The method of claim 9, wherein the repeatable action instructs the application to reclaim back each object allocated for the repeatable action.

11. The method of claim 10, wherein the objects includes the one or more memory nodes leaked by the repeatable action.

12. The method of claim 9, wherein the identification comprising:
determining a difference between the first and second collections of memory nodes, wherein the difference indicates the one or more memory nodes are leaked by the repeatable action.

13. The method of claim 9, further comprising:
determining if the one ore more memory nodes leaked by the repeatable action are allocated in a memory cache.

14. The method of claim 9, further comprising:
iterating obtaining snapshots of the collections and the repeatable action;
storing representation of the one ore more memory nodes for each iteration; and
comparing representations stored among multiple iterations to identify permanent memory nodes leaked by the repeatable action for each iteration.

15. The method of claim 14, wherein the permanent memory nodes are represented in each of a plurality of the stored representations and wherein the permanent memory nodes are represented for a latest iteration among the multiple iterations.

16. The method of claim 15, further comprising:
presenting a graphical interface indicating the permanent memory nodes leaked by the repeatable action at each iteration; and
updating the graphical interface at each iteration.

17. A machine-readable storage medium having instructions, when executed by a machine, cause the machine to perform a method, the method comprising:
obtaining a plurality of snapshots for system resource at different times, each snapshot indicating a collection of resource objects already allocated at a time of the snapshot;
correlating the plurality of snapshots, the correlation identifying permanent resource objects from the collection of resource objects; and
filtering the plurality of snapshots based on the correlation, wherein the filtered snapshots indicating the permanent resource objects identified.

18. A machine-readable storage medium having instructions, when executed by a machine, cause the machine to perform a method, the method comprising:
obtaining a snapshot of a first collection of memory nodes allocated for a system running an application having an execution state at a first instant;
performing a repeatable action of the application subsequent to the first instant, wherein the application maintains the execution state after the repeatable action;
obtaining a snapshot of a second collection of memory nodes allocated for the system running the application at a second time instance subsequent to the repeatable action; and
identifying one or more memory nodes from the first and second collections of memory nodes, the identified memory nodes representing permanent memory growth of the application along the first and second instants

19. An apparatus, comprising:
a memory storing executable instructions;
a user interface device;
a processor coupled to user interface device and the memory to execute the executable instructions from the memory, the processor being configured to:
obtain a snapshot of a collection of memory nodes allocated in the memory for an application;
perform a repeatable action of the application subsequent to the obtaining the snapshot;
repeat the obtaining the snapshot and the repeatable action;
correlate representations of collections of memory nodes among multiple iterations to identify permanent memory nodes leaked by the repeatable action for each of the multiple iterations; and
presenting a history of the permanent memory nodes leaked by the repeatable action across the multiple iterations.
